(19) United States
(12) Patent Application Publication
(10) Pub. No.: US 2022/0342267 A1
(43) Pub. Date: Oct. 27, 2022

(54) NANOFIBER ASSEMBLIES WITH MULTIPLE ELECTROCHROMIC STATES

(71) Applicant: LINTEC OF AMERICA, INC., Richardson, TX (US)

(72) Inventor: Jaeah LEE, Richardson, TX (US)

(73) Assignee: LINTEC OF AMERICA, INC., Richardson, TX (US)

(21) Appl. No.: 17/760,900

(22) PCT Filed: Sep. 11, 2020
(86) PCT No.: PCT/US2020/050320

§ 371 Date: Mar. 16, 2022

Related U.S. Application Data
(60) Provisional application No. 62/901,357, filed on Sep. 17, 2019.

(51) Int. Cl. G02F 1/1506; G02F 1/161; G02F 1/1516; G02F 1/163

(52) U.S. Cl. CPC G02F 1/1508; G02F 1/161; G02F 1/15165; G02F 1/163

(57) ABSTRACT

Composite assemblies are described that can be switched from a transparent state to a non transparent state, and in some examples even switched between different colors/reflectivities in the non transparent state. Switching between these states can be initiated by application of an electrical current to Ag carbon nanotube yarns in contact with an electrochromic electrolyte. The carbon nanotube yarns increase the efficiency with which electrons are provided to an electrolyte.

### CROSS-REFERENCE TO RELATED APPLICATIONS

This application claims priority under 35 U.S.C. § 119(e) to U.S. Provisional Application Ser. No. 62/901,357, titled “NANOFIBER ASSEMBLIES WITH MULTIPLE ELECTROCHROMIC STATES,” filed on Sep. 17, 2019, which is hereby incorporated by reference in its entirety for all purposes.

### TECHNICAL FIELD

The present disclosure relates generally to electrochromic displays. Specifically, the present disclosure relates to carbon nanofiber assemblies with multiple electrochromic states.

### BACKGROUND

Electrochromic materials are those that change color in response to an applied voltage. Generally, this phenomenon is accomplished via a reversible redox reaction in an electrochemical system. Inorganic and organic compounds can exhibit this behavior. Inorganic electrochromic materials include tungsten oxide (WO₃) and NiO. Organic electrochromic materials include viologens.

### SUMMARY

In a first example, an apparatus includes a first transparent film and a back plate, a spacer between the first transparent film and the back plate, the spacer disposed at a perimeter of the first transparent film and defining a chamber between the first transparent film and the back plate, an array of more than one silver-carbon nanofiber yarns between the first transparent film and the back plate, and an electrolyte between the array and the first transparent film and within the spacer.

Example 2 includes the subject matter of Example 1, wherein the electrolyte is a liquid electrochromic material.

Example 3 includes the subject matter of Example 2, wherein the liquid electrochromic material is injected into a chamber formed by the first transparent film, the spacer, the array, and the back plate.

Example 4 includes the subject matter of Example 3, wherein the liquid electrochromic material is cured into a solid electrochromic material by application of ultraviolet light.

Example 5 includes the subject matter of Example 1, wherein the electrolyte is a solid electrochromic material.

Example 6 includes the subject matter of Example 1, wherein at least one of PEDOT:PSS, polypyrrole, and polyaniline is applied to the array.

Example 7 includes the subject matter of Example 1, and further includes a carbon nanofiber sheet coated with silver between the array and the electrolyte.

Example 8 includes the subject matter of Example 1, wherein the electrolyte has at least a first electrochromic state and a second electrochromic state.

Example 9 includes the subject matter of Example 8, wherein the electrolyte is bi-stable.

Example 10 includes the subject matter of Example 8, wherein switching between the first electrochromic state and the second electrochromic state is a reversible process.

Example 11 includes the subject matter of Example 8, wherein the electrolyte is configured to switch between the first electrochromic state and the second electrochromic state by changing a polarity of electric current.

Example 12 includes the subject matter of Example 8, wherein the apparatus is configured to switch between the first electrochromic state and the second electrochromic state through application of between −3 volts and −2.5 volts.

Example 13 includes the subject matter of Example 8, wherein the apparatus is configured to switch between the second electrochromic state and the first electrochromic state through application of between 0 volts and 0.5 volts.

Example 14 is a method including assembling the apparatus of Example 1, injecting an electrolyte in a liquid state into a chamber formed by the first transparent film, the spacer, the array, and the back plate, and curing the electrolyte through application of ultraviolet light and converting the electrolyte from the liquid state to a solid state.

Example 15 includes the subject matter of Example 14, and further includes switching the electrolyte between at least a first electrochromic state and a second electrochromic state through application of a voltage.

Example 16 includes the subject matter of Example 15, wherein the electrolyte is bi-stable.

Example 17 includes the subject matter of Example 15, wherein switching between the first electrochromic state and the second electrochromic state is a reversible process.

Example 18 includes the subject matter of Example 15, wherein the electrolyte is configured to switch between the first electrochromic state and the second electrochromic state by changing a polarity of electric current.

Example 19 is a method including assembling the apparatus of Example 1, applying at least one of PEDOT:PSS, polypyrrole, and polyaniline to the array, and applying a voltage to the array to cause switching between a first electrochromic state and a second electrochromic state.

Example 20 includes the subject matter of Example 19, and further includes maintaining the application of the voltage for a period of at least 5 minutes, stopping the application of the voltage following the period, and maintaining the second electrochromic state for a period of at least 10 minutes absent further voltage application.

### BRIEF DESCRIPTION OF THE DRAWINGS

FIG. 1 illustrates an exploded view and cross-sectional view of an electrochromic assembly, in an example of the present disclosure.

FIG. 2 illustrates cross-sectional schematic views and corresponding experimental results of three different electrochromic states of an example of the present disclosure.

FIG. 3 illustrates formation of a “wet-spun” nanofiber sheet, and its application within an example of the present disclosure capable of mirror, transparent, and black electrochromic states, in an example of the present disclosure.

FIG. 4. is a photomicrograph of an example forest of nanofibers on a substrate, in an embodiment.

FIG. 5 is a schematic illustration of an example reactor for nanofiber growth, in an embodiment.

FIG. 6 is an illustration of a nanofiber sheet that identifies relative dimensions of the sheet and schematically illustrates nanofibers within the sheet aligned end-to-end in a plane parallel to a surface of the sheet, in an embodiment.

FIG. 7 is an SEM photomicrograph is an image of a nanofiber sheet being laterally drawn from a nanofiber forest, the nanofibers aligning from end-to-end as schematically illustrated.

The figures depict various embodiments of the present disclosure for purposes of illustration only. Numerous variations, configurations, and other embodiments will be apparent from the following detailed discussion.

### DETAILED DESCRIPTION

### Overview

Embodiments of the present disclosure include composite assemblies that can be switched from a transparent state to a non-transparent state, and in some examples even switched between different colors/reflectivities in the non-transparent state. Switching between these states can be initiated by application of an electrical current to an electrochromic electrolyte in contact with carbon nanofiber yarns that include a conductive material (e.g., silver). The carbon nanotube yarns increase the efficiency with which electrons are provided to the electrochromic electrolyte. This increased efficiency increases the rate of electrochemical reaction in the electrolyte and thus the rate at which the different electrochromic states can be achieved. In some examples, the composite film includes a first transparent film and a second transparent film, between which is an electrolyte, and a layer of a plurality of carbon nanotube yarns spun with silver, which may optionally be treated with poly(3,4-ethylenedioxythiophene) polystyrene sulfonate, also known as PEDOT:PSS. In some examples a spacer film is disposed between layers so as to contain the electrolyte between confronting transparent films.

In addition to reversibly changing colors and/or reflectivities, embodiments described herein can be bi-stable. That is, a given electrochromic state, once achieved, can be maintained even in the absence of an applied voltage. A prior electrochromic state can be achieved (i.e., an electrochromic transition can be reversed) by applying a voltage with an opposite polarity to that applied to achieve the current electrochromic state.

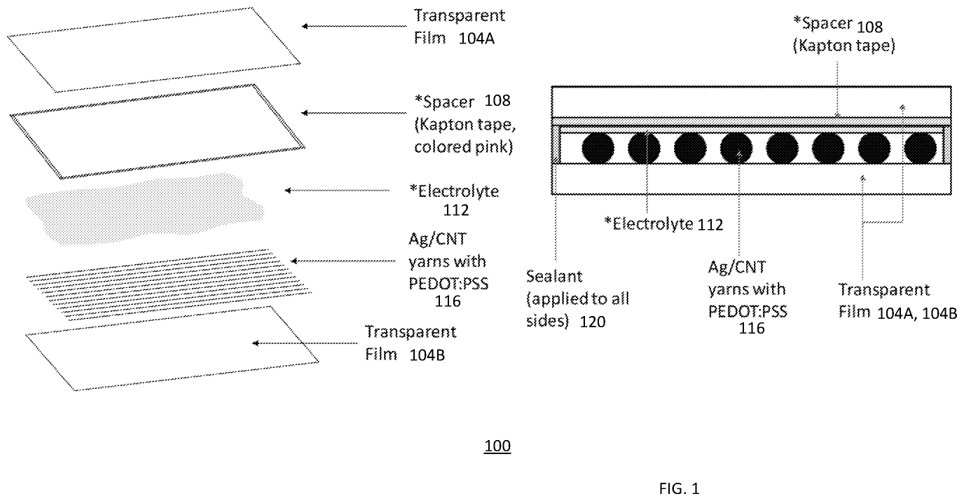

FIG. 1 illustrates an exploded view and a cross-sectional view of one example 100 of the present disclosure. The example 100 includes transparent films 104A, 104B, a spacer 108, electrolyte 112, and carbon nanotube yarns 116.

The transparent films 104A, 104B are used in the example 100 to contain the intervening layers/elements, and to provide an optically transparent layer through which the change between the electrochromic states (from transparent to opaque, between different colors/reflectivities, and/or combinations thereof) can be seen by the user. Examples of the transparent films 104A, 104B include but are not limited to polyethylene terephthalate (PET), polypropylene (PP), polyethylene (PE), polybutylene terephthalate (PBT), among others. In some examples, an optically transparent glass or glass ceramic (such as those used in touch sensitive mobile computing devices) may be used. Using a glass or glass ceramic as transparent film 104A, 104B has the advantage of providing mechanical rigidity to the example 100.

Spacer 108 can be placed on any two opposing sides of the transparent film 104A or on all four sides of the transparent film 104A. The spacer 108 can extend from 1 mm to several centimeters from a peripheral edge of the transparent film 104A into an interior of the transparent film so as to form a barrier or dam within which a liquid phase electrolyte 112 can be contained. Examples of the spacer 108 can include an adhesive tape or polymeric film (e.g., Kapton tape) that is from 50 μm to 500 μm thick.

In one example, the electrolyte 112 is a liquid electrolyte that is provided to the space defined by the spacer 108, the transparent film 104A, and ultimately the transparent film 104B (when assembled together). The method for fabrication will be described below in more detail. In one example, a liquid electrolyte is a solution of 50 molar % of lithium perchlorate (LiClO₄) and polycarbonate (PC). This electrolyte can produce electrochromic transitions from transparent to blue. In other examples described below, the electrolyte can have more than two electrochromic states. In some examples, silver particles can even be mixed with the preceding electrolyte to produce a mirror like electrochromic state. In some examples, the silver particles are 100 nm in diameter or less. In some examples, in the mirror like electrochromic state, a layer of silver particles is from 100 nm to 400 nm thick.

In another example, a solid electrolyte can be used as the electrolyte 112. The solid electrolyte can be composed by adding 25 molar %-50 molar % of polymethyl methacrylate (PMMA) in dimethyl formamide (DMF). 0.4-0.6 moles of lithium perchlorate (LiClO₄) and polycarbonate (PC) are then mixed with the preceding solution to produce the electrolyte 112. The solid electrolyte can then be cured into a solid phase using ultraviolet radiation after introduction into the chamber between the films 104A, 104B and further defined by the spacer 108. Alternatively, a liquid electrolyte can be polymerized into a solid state ex-situ and then placed between the films 104A, 104B. The solid electrolyte is generally less preferred for applications having a mirror-like electrochromic state.

The carbon nanofiber yarns 116 can act as a counter-electrode (also sometimes referred to as an “auxiliary electrode”) that increases the rate of electron transfer from a power source to the electrolyte 112. In some examples, the carbon nanofiber yarns 116 can be true twist or false twist nanofiber yarns, and single ply or multi-ply nanofiber yarns. The carbon nanofiber yarns 116 can have a diameter of between 3 μm and 10 μm. In some examples, the carbon nanofiber yarns have a diameter between 4 μm and 6 μm. The nanofiber yarns 116 can have an electrical resistance of from 10-20 Ohm/square and an optical light transmittance of greater than 90%. The carbon nanofiber yarns 116 can be electrically connected to one or more external electrodes that are used to provide electrical current to the carbon nanofiber yarns from an external power source.

### Method of Fabrication

In one example, an example of the present disclosure can be fabricated so as to have a first electrochromic state that is transparent and transition to a second electrochromic state that is a blue color. The electrochromic state is reversible upon a change in polarity of the electrical current.

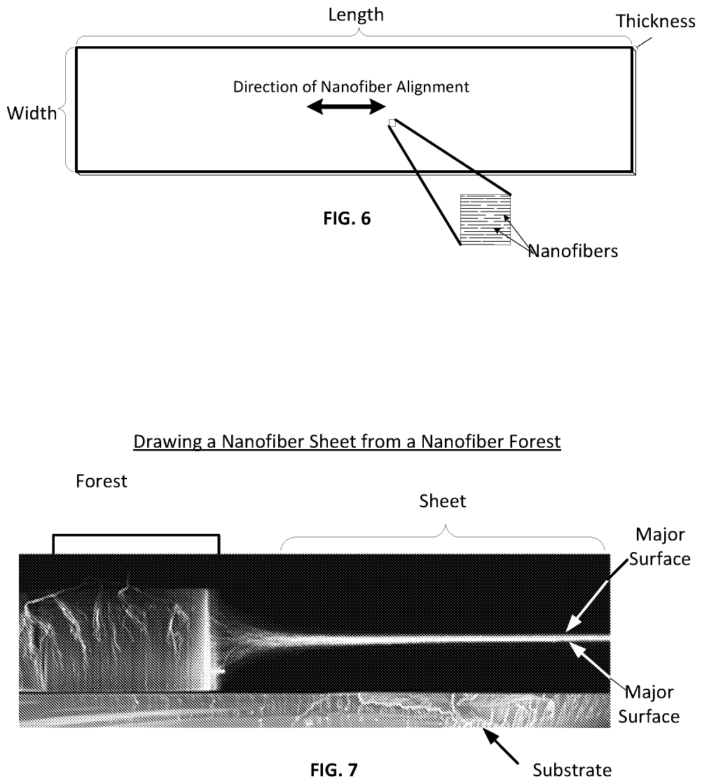

In some examples, the carbon nanofiber yarns can be fabricated from nanofiber sheets drawn from a nanofiber forest, as below in the context of FIGS. 6 and 7. In other examples, the carbon nanofiber yarns can be fabricated from a dispersion of individual nanofibers suspended in a solution. This latter technique includes the suspension of 0.1 wt. % to 0.3 wt. % of carbon nanotubes in a water-based, pH neutral solution. A surfactant (e.g., an amphiphilic surfactant) can be added to aid the dispersion of nanofibers in the solution. The solvent is placed in a rotating vacuum filter and rotated at speeds of at most 100 RPM while drawing a vacuum. The rotation of the filter (and/or the filter paper) and/or solution assists in the alignment of individual carbon nanofibers with one another. The nanofibers form a sheet on the filter paper. The filter paper can be separated from the sheet of carbon nanotubes, the latter of which can be as thin as 10 μm to 2 mm (depending on the volume of solution drawn through the filter and/or concentration of nanofibers in the solvent) and have an optical light transparency of from 70% to 90%.

In this example a carbon nanofiber sheet is provided and a layer of silver is formed on the carbon nanofiber sheet that is less than 500 nm thick. The layer of silver can be formed by eBeam deposition, physical vapor deposition or sputtering, among other techniques that are capable of forming the layer on the carbon nanofiber sheet without causing the carbon nanofiber sheet to bundle, buckle, or otherwise lose its uniformity or continuity.

The silver coated nanofiber sheet is then true-twisted or false-twisted into an Ag-carbon nanofiber yarn. Single ply yarns can be plied together to form a multi-ply yarn. As described above, diameters of the yarn can range from 3 μm to 10 μm. The Ag-carbon nanofiber yarns can be linearly arranged in an array on an optically transparent film (e.g., an adhesive film), with 150 μm to 200 μm separating adjacent Ag-carbon nanofiber yarns.

Poly(3,4-ethylenedioxythiophene) polystyrene sulfonate, also known as “PEDOT:PSS”, can then be applied to the Ag-carbon nanofiber array on the optically transparent film using spin coating, a “doctor blade” coating device, spray coating, among other techniques. PEDOT:PSS is an electrically conductive material that improves the conductivity of the Ag-carbon nanofibers. Alternative example conductive polymers include, but are not limited to, polypyrrole and polyaniline. In still other examples, the Ag-carbon nanofiber can be treated to include electrically conductive micro and/or nanoparticles (e.g., silver, gold, copper, aluminum, graphene) that are infiltrated into interfiber gaps defined by and between the nanofibers.

The spacer described above is then placed on the Ag-carbon nanofiber array and another optically transparent film is placed on (or around) the exposed surface of the Ag-carbon nanofiber array. The combination of the first optically transparent sheet, the Ag-carbon nanofiber array, the spacer, and the second optically transparent film form a chamber, into which electrolyte is placed. In some examples, a syringe or other injection mechanism can be used to introduce the liquid electrolyte into the chamber. For the appropriate composition, some liquid electrolytes can be cured into a solid electrolyte using UV radiation, as described above. A sealant can be applied to a perimeter, thus sealing the various components (in particular, a liquid electrolyte) within the assembly. Electrodes can be used to connect the Ag-carbon nanofibers to an external power source.

In the preceding example, application of −3V to −2.5V to the Ag-carbon nanofiber arrays causes the first electrochromic state, which is transparent, to change to a second electrochromic state, which is blue. This is believed to be caused by a reduction reaction within the electrolyte. Upon application of 0.5 V to assembly in the second electrochromic state, the assembly will revert back to the first electrochromic state, which is transparent. In some cases, applying a voltage for a longer period of time (e.g., at least 5 minutes) will enable the electrochromic state to persist even in the prolonged (e.g., more than 10 minutes) absence of the applied voltage. In other words, applying a voltage to this example for at least 5 minutes causes the electrolyte to transition to a stable electrochromic state in which the color associated with that state (e.g., blue) remains after prolonged absence (e.g., more than 10 minutes, more than 1 hour, more than 1 day) of the voltage. Thus, this embodiment can be referred to as having bi-stable electrochromic states. In one experimental example, the separation between Ag-carbon nanofiber yarns was 190 μm. A sheet resistance was 5 Ohm/square. In the first electrochromic state (transparent), the visible light transmittance was 91.6%.

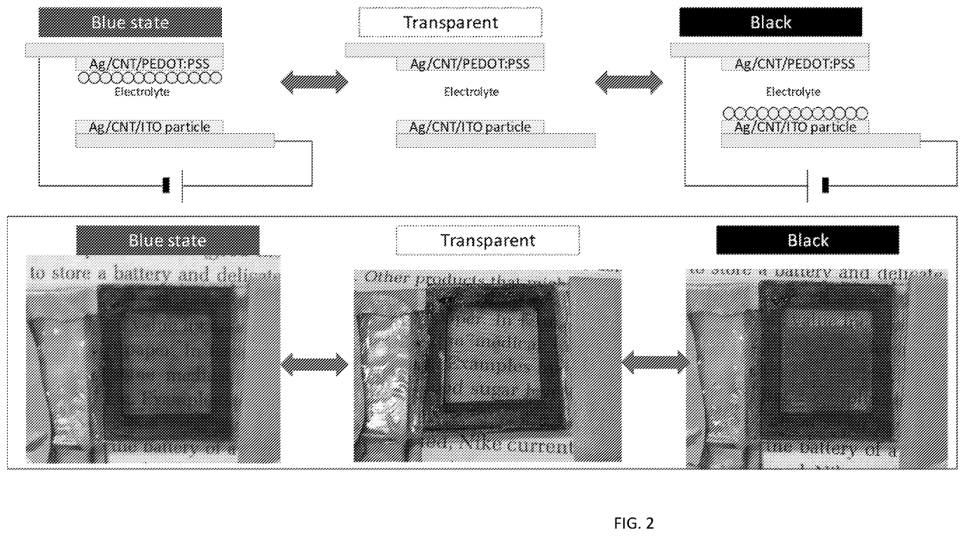

In another example, a composite nanofiber assembly of the present disclosure can be fabricated to have three or more electrochromic transitions, each having a different color from the others. A schematic cross-section and an experimental result of this example are shown in FIG. 2. Ag-carbon nanofiber yarns are fabricated, as described above. Yarns are placed into a first array (as described above) on a first optically transparent sheet and into a second array on a second optically transparent film. The first array of Ag-carbon nanofiber yarns are coated with PEDOT:PSS on the first film and the second array of Ag-carbon nanofiber yarns are coated with indium tin oxide (ITO). The coating can be accomplished using spin coating or doctor blade techniques. A spacer that is from 150 μm to 250 μm thick is placed around a perimeter of one of the transparent films. The first and second optically transparent films are placed together on opposite sides (but within the perimeter) of the spacer with the first and second array confronting one another and within the chamber defined by the spacer and the first and second optically transparent films. Liquid electrolyte is then injected into the chamber. Electrodes can be used to connect the Ag-carbon nanofibers to an external power source.

Upon application of −3V to −2.5V to the Ag-carbon nanofiber arrays, the first electrochromic state, which is transparent, changes to a second electrochromic state, which is blue. This is believed to be caused by a reduction reaction within the electrolyte. Upon application of from 0V to 0.5V to the second electrochromic state, the electrochromic state will transition back to the first electrochromic state (transparent). Upon application of from 2.5V to 3V, the first electrochromic state (transparent) will transition to a third electrochromic state (black). These states and the configuration of the various layers is schematically shown in FIG. 2.

In still another example, in which silver particles are included in the electrolyte solution, application of −3V to −2.5V can cause a first electrochromic state (transparent) to transition to second, a mirror-like electrochromic state. Applying from 0V to 0.5V will cause the second, mirror-like first electrochromic state to transition back to a transparent first electrochromic state.

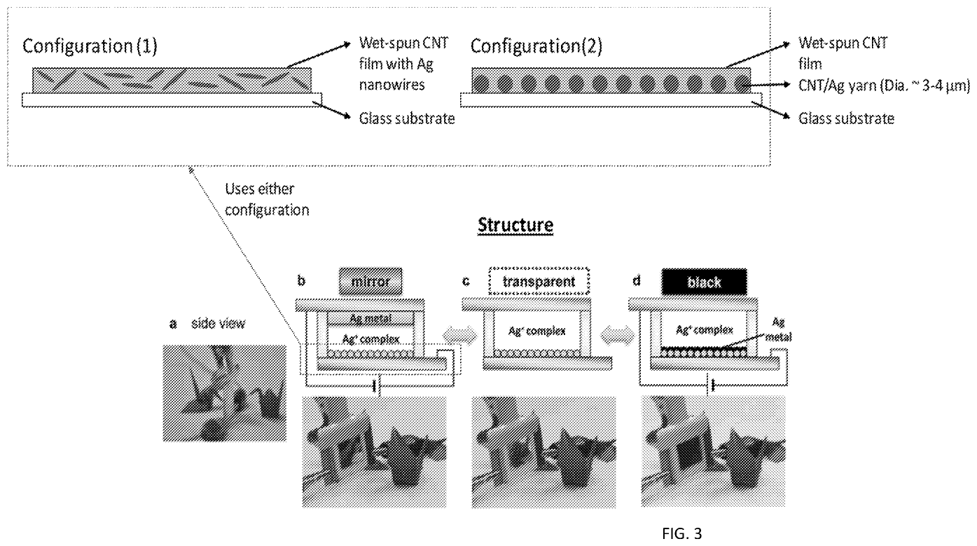

In an example in which a mirror-like transition is desired, a sheet of carbon nanotubes, made using the dispersion method described above, can be placed between the Ag-carbon nanofiber array and the electrolyte solution. This is illustrated in FIG. 3. This sheet of carbon nanotubes is placed in the above-described embodiment between the Ag-carbon nanofiber array and the electrolyte solution (which in this case includes silver ion (Ag⁺) complexes). Other elements of the above configuration and process remain the same. The smooth surface of the sheet increases the reflectivity in its second electrochromic state. In one example, the sheet of carbon nanotubes is made with up to 30 mass % carbon nanotubes and up to 80 mass % silver (Ag) (the total being 100 mass 5). In some examples, this Ag-carbon nanotube sheet can replace the Ag-carbon nanofiber array entirely.

### Example Applications

Examples of the present disclosure can be affixed to, integrated with, or placed proximate to windows and mirrors to create a window that can be reversibly switched between two or three electrochromic states (e.g., transparent-blue; transparent-blue-black; transparent-mirror). Because voltages less than +/−3V can be used to cause these electrochromic transitions, examples of the present disclosure can be operated using batteries (e.g., disposable alkaline batteries, rechargeable batteries).

Transition times are a function (in part) of a surface area of the assembly. Areas less than 0.5 m² can transition from one state to another in 15 seconds or less, whereas areas that are 1 m² or greater may require a minute to 5 minutes to transition.

### Nanofiber Forests

As used herein, the term “nanofiber” means a fiber having a diameter less than 1 μm. While the embodiments herein are primarily described as fabricated from carbon nanotubes, it will be appreciated that other carbon allotropes, whether graphene, micron or nano-scale graphite fibers and/or plates, and even other compositions of nano-scale fibers such as boron nitride may be densified using the techniques described below. As used herein, the terms “nanofiber” and “carbon nanotube” encompass both single walled carbon nanotubes and/or multi-walled carbon nanotubes in which carbon atoms are linked together to form a cylindrical structure. In some embodiments, carbon nanotubes as referenced herein have between 4 and 10 walls. As used herein, a “nanofiber sheet” or simply “sheet” refers to a sheet of nanofibers aligned via a drawing process (as described in PCT Publication No. WO 2007/015710, and incorporated by reference herein in its entirety) so that a longitudinal axis of a nanofiber of the sheet is parallel to a major surface of the sheet, rather than perpendicular to the major surface of the sheet (i.e., in the as-deposited form of the sheet, often referred to as a “forest”). This is illustrated and shown in FIGS. 6 and 7, respectively.

The dimensions of carbon nanotubes can vary greatly depending on production methods used. For example, the diameter of a carbon nanotube may be from 0.4 nm to 100 nm and its length may range from 10 μm to greater than 55.5 cm. Carbon nanotubes are also capable of having very high aspect ratios (ratio of length to diameter) with some as high as 132,000,000:1 or more. Given the wide range of dimensional possibilities, the properties of carbon nanotubes are highly adjustable, or “tunable.” While many intriguing properties of carbon nanotubes have been identified, harnessing the properties of carbon nanotubes in practical applications requires scalable and controllable production methods that allow the features of the carbon nanotubes to be maintained or enhanced.

Due to their unique structure, carbon nanotubes possess particular mechanical, electrical, chemical, thermal and optical properties that make them well-suited for certain applications. In particular, carbon nanotubes exhibit superior electrical conductivity, high mechanical strength, good thermal stability and are also hydrophobic. In addition to these properties, carbon nanotubes may also exhibit useful optical properties. For example, carbon nanotubes may be used in light-emitting diodes (LEDs) and photo-detectors to emit or detect light at narrowly selected wavelengths. Carbon nanotubes may also prove useful for photon transport and/or phonon transport.

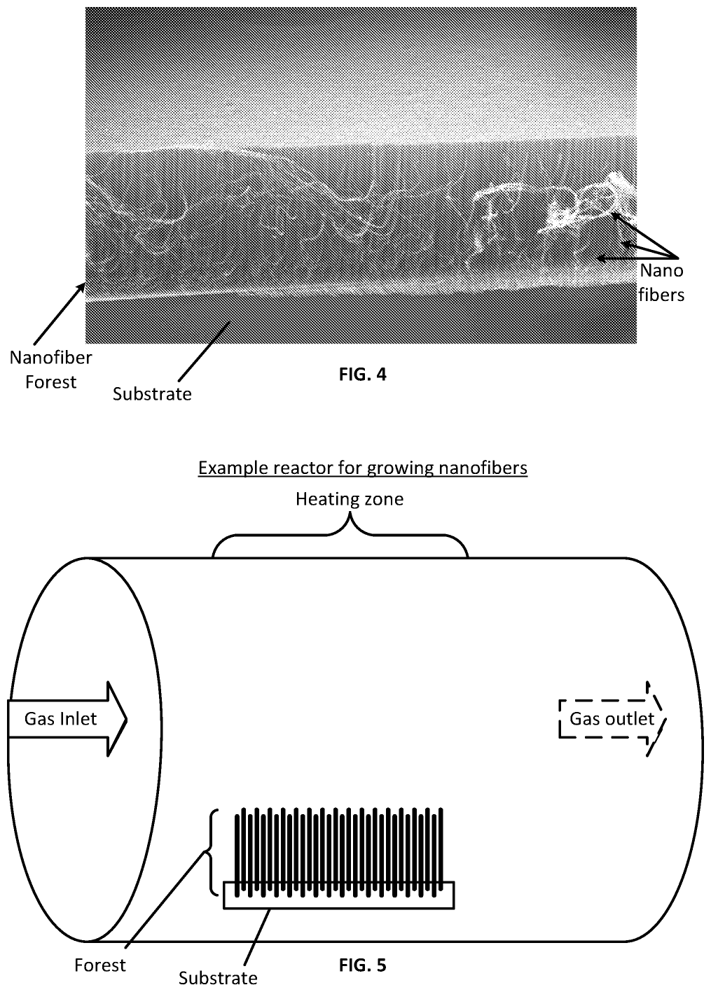

In accordance with various embodiments of the subject disclosure, nanofibers (including but not limited to carbon nanotubes) can be arranged in various configurations, including in a configuration referred to herein as a “forest.” As used herein, a “forest” of nanofibers or carbon nanotubes refers to an array of nanofibers having approximately equivalent dimensions that are arranged substantially parallel to one another on a substrate. FIG. 4 shows an example forest of nanofibers on a substrate. The substrate may be any shape but in some embodiments the substrate has a planar surface on which the forest is assembled. As can be seen in FIG. 4, the nanofibers in the forest may be approximately equal in height and/or diameter.

Nanofiber forests as disclosed herein may be relatively dense. Specifically, the disclosed nanofiber forests may have a density of at least 1 billion nanofibers/cm2. In some specific embodiments, a nanofiber forest as described herein may have a density of between 10 billion/cm2 and 30 billion/cm2. In other examples, the nanofiber forest as described herein may have a density in the range of 90 billion nanofibers/cm2. The forest may include areas of high density or low density and specific areas may be void of nanofibers. The nanofibers within a forest may also exhibit inter-fiber connectivity. For example, neighboring nanofibers within a nanofiber forest may be attracted to one another by van der Waals forces. Regardless, a density of nanofibers within a forest can be increased by applying techniques described herein.

Methods of fabricating a nanofiber forest are described in, for example, PCT No. WO2007/015710, which is incorporated herein by reference in its entirety.

Various methods can be used to produce nanofiber precursor forests. For example, in some embodiments nanofibers may be grown in a high-temperature furnace, schematically illustrated in FIG. 5. In some embodiments, catalyst may be deposited on a substrate, placed in a reactor and then may be exposed to a fuel compound that is supplied to the reactor. Substrates can withstand temperatures of greater than 800° C. or even 1000° C. and may be inert materials. The substrate may comprise stainless steel or aluminum disposed on an underlying silicon (Si) wafer, although other ceramic substrates may be used in place of the Si wafer (e.g., alumina, zirconia, SiO2, glass ceramics). In examples where the nanofibers of the precursor forest are carbon nanotubes, carbon-based compounds, such as acetylene may be used as fuel compounds. After being introduced to the reactor, the fuel compound(s) may then begin to accumulate on the catalyst and may assemble by growing upward from the substrate to form a forest of nanofibers. The reactor also may include a gas inlet where fuel compound(s) and carrier gasses may be supplied to the reactor and a gas outlet where expended fuel compounds and carrier gases may be released from the reactor. Examples of carrier gases include hydrogen, argon, and helium. These gases, in particular hydrogen, may also be introduced to the reactor to facilitate growth of the nanofiber forest. Additionally, dopants to be incorporated in the nanofibers may be added to the gas stream.

In a process used to fabricate a multilayered nanofiber forest, one nanofiber forest is formed on a substrate followed by the growth of a second nanofiber forest in contact with the first nanofiber forest. Multi-layered nanofiber forests can be formed by numerous suitable methods, such as by forming a first nanofiber forest on the substrate, depositing catalyst on the first nanofiber forest and then introducing additional fuel compound to the reactor to encourage growth of a second nanofiber forest from the catalyst positioned on the first nanofiber forest. Depending on the growth methodology applied, the type of catalyst, and the location of the catalyst, the second nanofiber layer may either grow on top of the first nanofiber layer or, after refreshing the catalyst, for example with hydrogen gas, grow directly on the substrate thus growing under the first nanofiber layer. Regardless, the second nanofiber forest can be aligned approximately end-to-end with the nanofibers of the first nanofiber forest although there is a readily detectable interface between the first and second forest. Multi-layered nanofiber forests may include any number of forests. For example, a multi-layered precursor forest may include two, three, four, five or more forests.

### Nanofiber Sheets

In addition to arrangement in a forest configuration, the nanofibers of the subject application may also be arranged in a sheet configuration. As used herein, the term “nanofiber sheet,” “nanotube sheet,” or simply “sheet” refers to an arrangement of nanofibers where the nanofibers are aligned end to end in a plane. An illustration of an example nanofiber sheet is shown in FIG. 6 with labels of the dimensions. In some embodiments, the sheet has a length and/or width that is more than 100 times greater than the thickness of the sheet. In some embodiments, the length, width or both, are more than 10³, 10⁶ or 10⁹ times greater than the average thickness of the sheet. A nanofiber sheet can have a thickness of, for example, between approximately 5 nm and 30 μm and any length and width that are suitable for the intended application. In some embodiments, a nanofiber sheet may have a length of between 1 cm and 10 meters and a width between 1 cm and 1 meter. These lengths are provided merely for illustration. The length and width of a nanofiber sheet are constrained by the configuration of the manufacturing equipment and not by the physical or chemical properties of any of the nanotubes, forest, or nanofiber sheet. For example, continuous processes can produce sheets of any length. These sheets can be wound onto a roll as they are produced.

As can be seen in FIG. 6, the axis in which the nanofibers are aligned end-to end is referred to as the direction of nanofiber alignment. In some embodiments, the direction of nanofiber alignment may be continuous throughout an entire nanofiber sheet. Nanofibers are not necessarily perfectly parallel to each other and it is understood that the direction of nanofiber alignment is an average or general measure of the direction of alignment of the nanofibers.

Nanofiber sheets may be assembled using any type of suitable process capable of producing the sheet. In some example embodiments, nanofiber sheets may be drawn from a nanofiber forest. An example of a nanofiber sheet being drawn from a nanofiber forest is shown in FIG. 7.

As can be seen in FIG. 7, the nanofibers may be drawn laterally from the forest and then align end-to-end to form a nanofiber sheet. In embodiments where a nanofiber sheet is drawn from a nanofiber forest, the dimensions of the forest may be controlled to form a nanofiber sheet having particular dimensions. For example, the width of the nanofiber sheet may be approximately equal to the width of the nanofiber forest from which the sheet was drawn. Additionally, the length of the sheet can be controlled, for example, by concluding the draw process when the desired sheet length has been achieved.

Nanofiber sheets have many properties that can be exploited for various applications. For example, nanofiber sheets may have tunable opacity, high mechanical strength and flexibility, thermal and electrical conductivity, and may also exhibit hydrophobicity. Given the high degree of alignment of the nanofibers within a sheet, a nanofiber sheet may be extremely thin. In some examples, a nanofiber sheet is on the order of approximately 10 nm thick (as measured within normal measurement tolerances), rendering it nearly two-dimensional. In other examples, the thickness of a nanofiber sheet can be as high as 200 nm or 300 nm. As such, nanofiber sheets may add minimal additional thickness to a component.

As with nanofiber forests, the nanofibers in a nanofibers sheet may be functionalized by a treatment agent by adding chemical groups or elements to a surface of the nanofibers of the sheet and that provide a different chemical activity than the nanofibers alone. Functionalization of a nanofiber sheet can be performed on previously functionalized nanofibers or can be performed on previously unfunctionalized nanofibers. Functionalization can be performed using any of the techniques described herein including, but not limited to CVD, and various doping techniques.

Nanofiber sheets, as drawn from a nanofiber forest, may also have high purity, wherein more than 90%, more than 95% or more than 99% of the weight percent of the nanofiber sheet is attributable to nanofibers, in some instances. Similarly, the nanofiber sheet may comprise more than 90%, more than 95%, more than 99% or more than 99.9% by weight of carbon.

### Further Considerations

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. An apparatus comprising:
a first transparent film and a back plate;
a spacer between the first transparent film and the back plate, the spacer disposed at a perimeter of the first transparent film and defining a chamber between the first transparent film and the back plate;
an array of more than one silver-carbon nanofiber yarns between the first transparent film and the back plate; and
an electrolyte between the array and the first transparent film and within the spacer.

2. The apparatus of claim 1, wherein the electrolyte is a liquid electrochromic material.

3. The apparatus of claim 2, wherein the liquid electrochromic material is injected into a chamber formed by the first transparent film, the spacer, the array, and the back plate.

4. The apparatus of claim 3, wherein the liquid electrochromic material is cured into a solid electrochromic material by application of ultraviolet light.

5. The apparatus of claim 1, wherein the electrolyte is a solid electrochromic material.

6. The apparatus of claim 1, wherein at least one of PEDOT:PSS, polypyrrole, and polyaniline is applied to the array.

7. The apparatus of claim 1, further comprising a carbon nanofiber sheet coated with silver between the array and the electrolyte.

8. The apparatus of claim 1, wherein the electrolyte has at least a first electrochromic state and a second electrochromic state.

9. The apparatus of claim 8, wherein the electrolyte is bi-stable.

10. The apparatus of claim 8, wherein switching between the first electrochromic state and the second electrochromic state is a reversible process.

11. The apparatus of claim 8, wherein the electrolyte is configured to switch between the first electrochromic state and the second electrochromic state by changing a polarity of electric current.

12. The apparatus of claim 8, wherein the apparatus is configured to switch between the first electrochromic state and the second electrochromic state through application of between −3 volts and −2.5 volts.

13. The apparatus of claim 8, wherein the apparatus is configured to switch between the second electrochromic state and the first electrochromic state through application of between 0 volts and 0.5 volts.

14. A method, comprising:
assembling the apparatus of claim 1;
injecting an electrolyte in a liquid state into a chamber formed by the first transparent film, the spacer, the array, and the back plate; and
curing the electrolyte through application of ultraviolet light and converting the electrolyte from the liquid state to a solid state.

15. The method of claim 14, further comprising switching the electrolyte between at least a first electrochromic state and a second electrochromic state through application of a voltage.

16. The method of claim 15, wherein the electrolyte is bi-stable.

17. The method of claim 15, wherein switching between the first electrochromic state and the second electrochromic state is a reversible process.

18. The method of claim 15, wherein the electrolyte is configured to switch between the first electrochromic state and the second electrochromic state by changing a polarity of electric current.

19. A method, comprising:
assembling the apparatus of claim 1;
applying at least one of PEDOT:PSS, polypyrrole, and polyaniline to the array; and
applying a voltage to the array to cause switching between a first electrochromic state and a second electrochromic state.

20. The method of claim 19, further comprising maintaining the application of the voltage for a period of at least 5 minutes, stopping the application of the voltage following the period, and maintaining the second electrochromic state for a period of at least 10 minutes absent further voltage application.
